(19) United States
(12) Patent Application Publication
(10) Pub. No.: US 2007/0118884 A1
(43) Pub. Date: May 24, 2007

(54) Name resolution system using name registration intermediary and name resolution intermediary

(76) Inventors: Satoshi Ozaki, Kawasaki-shi (JP); Kotaro Ise, Saitama-shi (JP); Seijiro Yoneyama, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/948,563

(22) Filed: Sep. 24, 2004

(30) Foreign Application Priority Data
Sep. 25, 2003 (JP) P2003-332821

(51) Int. Cl. H04L 9/32

(52) U.S. Cl. 726/5

(57) ABSTRACT

The name resolution system has a name registration intermediary device for intermediating between a name resolution server and a communication device which transmits a registration request for registering a set of a name and an address of the communication device as an address information of the communication device to the name resolution server, and a name registration intermediary device for intermediating between a name resolution server and a communication device which transmits a name resolution request for requesting a name resolution of a desired communication device to the name resolution server, which convert an original name of the communication device contained in the request into another name by using an encryption key.

### BACKGROUND OF THE INVENTION

1. Field of the Invention

The present invention relates to a name resolution system for resolving an address according to a name of a communication device, and more particularly to a name resolution system which realizes a name resolution according to a converted name of a communication device by using a name registration intermediary device and name resolution intermediary device.

2. Description of the Related Art

A communication device on a network is given an address such as IP address in order to identify each communication device. IP is widely used in various communications such as Internet. The IP address is also necessary when the user specifies a communication device on a network, but the IP address is just a string of alphanumeric characters which is unintelligible for the user. In many cases, an address which is more intelligible to the user is defined separately from the IP address, and a system for converting this address into the IP address is used. One example is a service called DNS (Domain Name System), and the conversion of the address into the IP address is referred to as the name resolution. The address used here has a character string called a domain name which indicates a location of that communication device (an area to which that communication device belongs), and a host name which is the name of the communication device (by which the communication device is identified within an area indicated by the domain name), such that this communication device is identified by the host name and the domain name.

However, any communication device is allowed to receive the DNS service, so that anyone can access the content registered at a DNS server which provides the DNS function. Also there are some customary ways of naming the host name by expressing a function of the host to some extent for the sake of convenience, such as “www” indicates a Web server, so that what kind of communication device it is can be guessed by looking at the host name that is publicly disclosed by the DNS.

For further detail of the DNS, see RFC3467, IETF, http://www.ietf.org/rfc/rfc3467.txt?number-3487.

Thus, the conventional name resolution system has a problem that the content of the DNS server is freely accessible by anyone and what kind of communication device it is can be ascertained from the registered domain name and host name. For a communication device which is preferably not publicly disclosed such as a communication device connected to a personal indoor network, the registration to the DNS server implies it will be known to unspecified many others.

### BRIEF SUMMARY OF THE INVENTION

It is therefore an object of the present invention to provide a name resolution system in which the name resolution is possible as usual for specific users, but the name resolution becomes impossible-for unspecified many third parties.

According to one aspect of the present invention there is provided a name registration intermediary device for intermediating between a name resolution device for obtaining an address of arbitrary communication device from a name of the arbitrary communication device and a communication device which transmits a registration request for registering a set of a name and an address of the communication device as an address information of the communication device to the name resolution device, the name registration intermediary device comprising: a reception unit configured to receive the registration request from the communication device; a conversion unit configured to convert an original name of the communication device contained in the registration request into another name by using an encryption key; and a transmission unit configured to replace the original name contained in the registration request by the another name obtained by the conversion unit and transmit the registration request containing the another name to the name resolution device.

According to another aspect of the present invention there is provided a name resolution intermediary device for intermediating between a name resolution device for obtaining an address of arbitrary communication device from a name of the arbitrary communication device and a communication device which transmits a name resolution request for requesting a name resolution of a desired communication device to the name resolution device, the name resolution intermediary device comprising: a reception unit configured to receive the name resolution request from the communication device; a conversion unit configured to convert an original name of the desired communication device contained in the name resolution request into another name by using an encryption key; and a transmission unit configured to replace the original name contained in the name resolution request by the another name obtained by the conversion unit, and transmit the name resolution request containing the another name to the name resolution device which registers the desired communication device by using the another name.

According to another aspect of the present invention there is provided a name resolution system for obtaining an address of arbitrary communication device from a name of the arbitrary communication device, the name resolution system comprising: a conversion unit configured to convert an original name of a communication device into another name by using an encryption key; a memory unit configured to store the another name obtained by the conversion unit and an address of the communication device in correspondence; a registration request reception unit configured to receive from a certain communication device a registration request for registering a set of a first original name and a first address of the certain communication device as an address information of the certain communication device; a first control unit configured to control the conversion unit to convert a first original name contained in the registration request into a first another name, and control the memory unit to store the first another name obtained by the conversion unit and the first address contained in the registration request in correspondence, when the registration request is received by the registration request reception unit; a search unit configured to search a specific another name stored in the memory unit, and retrieving a specific address stored in the memory unit in correspondence to the specific another name; a name resolution request reception unit configured to receive from one communication device a name resolution request for requesting a name resolution of a desired communication device; a second control unit configured to control the conversion unit to convert a second original name of the desired communication device contained in the name resolution request into a second another name, and control the search unit to retrieve a second address stored in the memory unit in correspondence to the second another name obtained by the conversion unit, when the name resolution request is received by the name resolution request reception unit; and a transmission unit configured to transmit the second address retrieved by the search unit as a response to the name resolution request to the one communication device.

According to another aspect of the present invention there is provided a name resolution method for obtaining an address of arbitrary communication device from a name of the arbitrary communication device, the name resolution method comprising: (a) receiving from a certain communication device a registration request for registering a set of a first original name and a first address of the certain communication device as an address information of the certain communication device; (b) converting the first original name of the certain communication device into a first another name by using an encryption key; (c) storing the first another name and an address of the certain communication device in correspondence in a memory; (d) receiving from one communication device a name resolution request for requesting a name resolution of a desired communication device: (e) converting a second original name of the desired communication device into a second another name by using the encryption key; (f) searching the second another name stored in a memory, and retrieving a second address stored in the memory in correspondence to the second another name; and (g) transmitting the second address as a response to the name resolution request to the one communication device.

According to another aspect of the present invention there is provided a computer program product for causing a computer to function as a name registration intermediary device for intermediating between a name resolution device for obtaining an address of arbitrary communication device from a name of the arbitrary communication device and a communication device which transmits a registration request for registering a set of a name and an address of the communication device as an address information of the communication device to the name resolution device, the computer program product comprising: a first computer program code for causing the computer to receive the registration request from the communication device; a second computer program code for causing the computer to convert an original name of the communication device contained in the registration request into another name by using an encryption key; and a third computer program code for causing the computer to replace the original name contained in the registration request by the another name obtained by the conversion unit, and transmit the registration request containing the another name to the name resolution device.

According to another aspect of the present invention there is provided a computer program product for causing a computer to function as a name registration intermediary device for intermediating between a name resolution device for obtaining an address of arbitrary communication device from a name of the arbitrary communication device and a communication device which transmits a name resolution request for requesting a name resolution of a desired communication device to the name resolution device, the computer program product comprising: a first computer program code for causing the computer to receive the name resolution request from the communication device; a second computer program code for causing the computer to convert an original name of the desired communication device contained in the name resolution request into another name by using an encryption key; and a third computer program code for causing the computer to replace the original name contained in the name resolution request by the another name obtained by the conversion unit, and transmit the name resolution request containing the another name to the name resolution device which registers the desired communication device by using the another name.

Other features and advantages of the present invention will become apparent from the following description taken in conjunction with the accompanying drawings.

### BRIEF DESCRIPTION OF THE DRAWINGS

FIG. 1 is a schematic diagram showing an exemplary configuration of a name resolution system according to the present invention.

FIG. 2 is a block diagram showing an exemplary configuration of a name registration intermediary device in the name resolution system of FIG. 1.

FIG. 3 is a block diagram showing an exemplary configuration of a name resolution intermediary device in the name resolution system of FIG. 1.

FIG. 4 is a flow chart showing an exemplary processing procedure of a registration request conversion unit in the name registration intermediary device of FIG. 2 and a query conversion unit in the name resolution intermediary device of FIG. 3 according to the first embodiment.

FIG. 5 is a diagram showing an exemplary FQDN conversion carried out by a registration request conversion unit in the name registration intermediary device of FIG. 2 and a query conversion unit in the name resolution intermediary device of FIG. 3 according to the first embodiment.

FIG. 8 is a flow chart showing an exemplary processing procedure of a registration request conversion unit in the name registration intermediary device of FIG. 2 and a query conversion unit in the name resolution intermediary device of FIG. 3 according to the second embodiment.

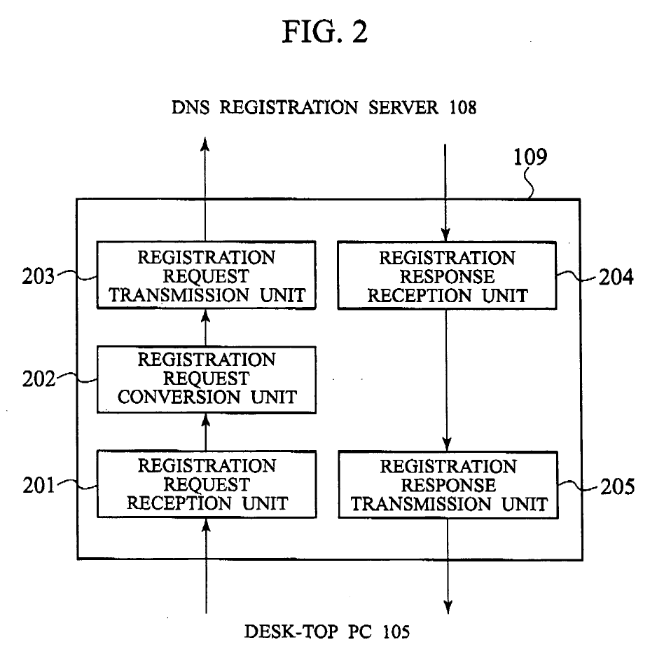

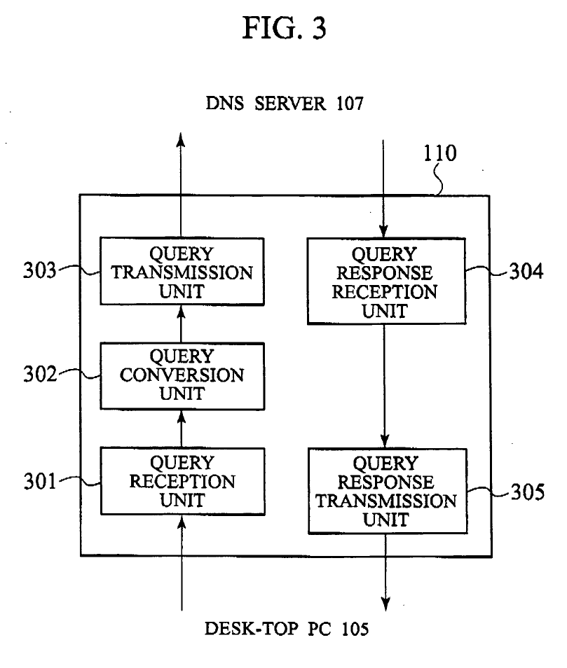

FIG. 7 is a diagram showing an exemplary FQDN conversion carried out by a registration request conversion unit in the name registration intermediary device of FIG. 2 and a query conversion unit in the name resolution intermediary device of FIG. 3 according to the second embodiment.

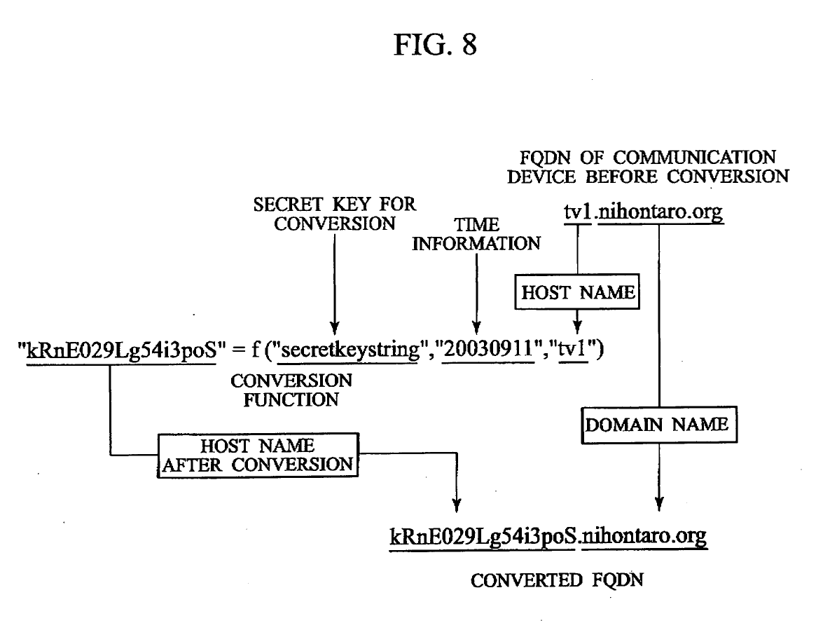

FIG. 8 is a diagram showing another exemplary FQDN conversion carried out by a registration request conversion unit in the name registration intermediary device of FIG. 2 and a query conversion unit in the name resolution intermediary device of FIG. 3 according to the second embodiment.

### DETAILED DESCRIPTION OF THE INVENTION

In recent years, the home electronics device has become highly functional and there are propositions for hereto unavailable way of utilizing the home electronics device such as delivering music data through a network. Also, when the home electronics device is connected to a network, it becomes possible to control the home electronics device remotely through a network. When a new protocol such as IPv6 which can express practically infinitely many IP addresses becomes widely spread, it will become possible for every home electronics device to have a unique IP address.

In order to carry out communications by using the communication device, it is necessary to ascertain the IP address of a correspondent, but when even a device such as home electronics device is going to have the IP address, it is expected that the number of IP addresses in use becomes enormous. It is impossible for the user to comprehend the IP addresses of all the communication devices, so that in practice it is inevitable to identify the communication device by the host name and the domain name by utilizing a mechanism of the name resolution such as DNS. It is possible for the DNS to construct a service in a local range such as Inside a home. However, when an indoor communication device is to be controlled from an outdoor network, it is necessary to realize the name resolution of the indoor communication device on the outdoor network. If the address information of the indoor communication device is registered to the DNS on the outdoor network for this purpose, for example, the name resolution of the indoor communication device on the outdoor becomes possible.

The name resolution system of the present invention presupposes that the name resolution of the indoor communication device is possible by using a name resolution system available to unspecified many third parties such as the outdoor DNS.

### First Embodiment

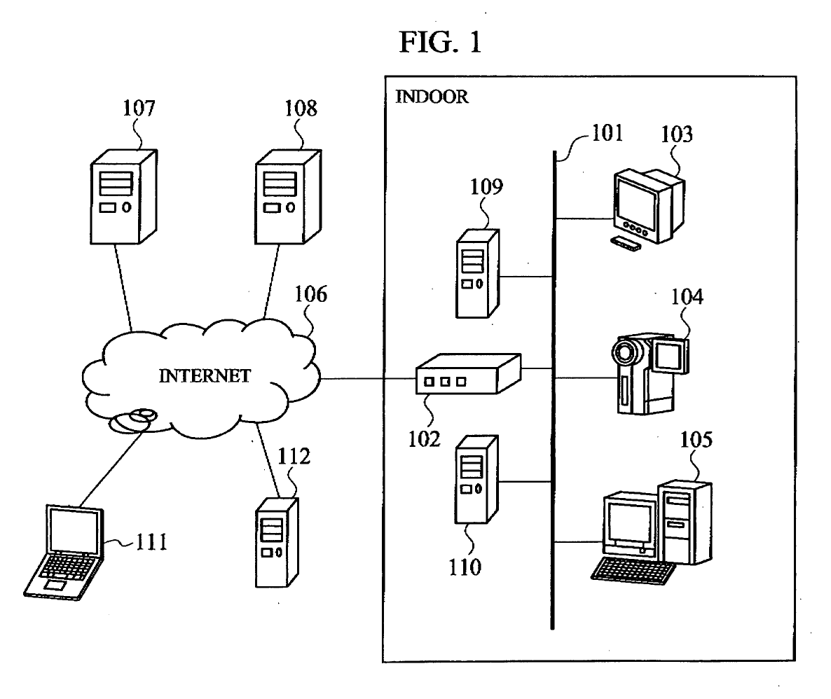

FIG. 1 shows an exemplary configuration of a name resolution system according to this system, which comprises an indoor LAN 101, a home router 102, a TV 103, a video camera 104, a desk-top PC 105, Internet 106, a DNS server 107, a DNS registration server 108, a name registration intermediary device 109, a name resolution intermediary device 110, a portable PC 111, and an outdoor name resolution intermediary device 112.

The indoor LAN 101 is a network constructed inside a personal home, for example, to which wired or wireless communication devices arranged inside the home are connected.

The home router 102 connects the indoor LAN 101 and the Internet 106, and has a function for transferring (routing) packets when the indoor communication device communicates with a communication device on the Internet 106. Here, it is also possible to equip a firewall function for preventing the illegal intrusion over the Internet 106 from the external.

The TV 103 is connected with the indoor LAN 101 and equipped with a function for communicating with the other communication devices. For example, it is possible to receive video data through the indoor LAN 101 and display it as video. The TV 103 is assigned with an IP address in order to be able to carry out IP communications. In addition, the TV 103 is assigned with a FQDN (Fully Qualified Domain Name) corresponding to the assigned IP address. The FQDN is a combination of a name (host name: “tv1”, for example) indicating the TV 103 and an address (domain name: “nihontaro.org”, for example) indicating a location of this TV 103. The FQDN for each communication device should be set uniquely on the network, so that it is a complete name indicating this TV 103 (“tv1.nihontaro.org” in the above example). The character string constituting the FQDN may be localized in accordance with the utilization circumstances of each nation. In Japan, the naming using kanji characters is also possible in this case.

The video camera 104 is connected with the indoor LAN 101 and equipped with a function for communicating with the other communication devices. For example, it is possible to transmit video data to the TV 103 through the indoor LAN 101, or record received video data. The video camera 104 is assigned with the IP address and the FQDN, similarly as the TV 103.

The desk-top PC 105 is connected with the indoor LAN 101 so that it can communicate with the other communication devices. It has a general purpose computation device and a memory device, and it is capable of executing applications. The desk-top PC 105 is also assigned with the IP address and the FQDN.

The DNS server 107 is a server device on the Internet 106 which is set up for the purpose of providing the DNS service. It has functions for receiving a name resolution request (query) as specified by the DNS protocol, and returning a response indicating the IP address assigned to a communication device of the name resolution target which is contained in a received packet. Also, when a registration request for the IP address and the FQDN for a certain communication device is received according to the DNS protocol, their information is stored as a set. In the following, this information on a set of the IP address and the FQDN will be referred to as an address information. The stored address information will be read out and used as a query result, when a query is received from another communication device and the matching one is found.

The DNS registration server 108 has a function for registering sets of the IP address and the FQDN to the DNS server 107. The DNS registration server 108 may be realized as a function of the DNS 107 without using a separate casing.

The name registration intermediary device 109 has a function for intermediating communications between the indoor communication device and the DNS registration server 108, when the indoor communication device tries to make the registration of its address information to the DNS server 107 through the DNS registration server 108. It is also possible to provide a function of the name registration intermediary device 109 at the DNS registration server 108 for the purpose of forming a single communication device which integrates all functions related to the registration to the DNS server.

The name resolution intermediary device 110 has a function for intermediating communications between the DNS server 107 on the Internet 106 and the indoor communication device, when the indoor communication device tries to acquire the IP address of a communication device by utilizing the DNS. It is also possible to provide a function of the name resolution intermediary device 110 at the DNS server 107 for the purpose of forming a single communication device which integrates all functions related to the name resolution.

The portable PC 111 is connected to the Internet 106, and has functions for operating the indoor communication device from the Internet 106, and transmitting data to the indoor communication device and receiving data from the indoor communication device, Prior to the communication with the indoor communication device, its IP address corresponding to the FQDN of the target indoor communication device is obtained from the DNS server 107. Here, the IP address is acquired by accessing the DNS server 107 through the outdoor name resolution intermediary device 112.

The outdoor name resolution intermediary device 112 is basically equivalent to the name resolution intermediary device 110 provided inside the home. It has a function for intermediating communications between the DNS server 107 on the Internet 106 and the communication device connected to the Internet 106 such as the portable PC 111, when such a communication device tries to acquire the IP address of a communication device by utilizing the DNS. The function of the outdoor name resolution Intermediary device 112 may be implemented by hardware or software on the portable PC 111. When it is Implemented on the portable PC 111, it becomes unnecessary to provide a device for intermediating the name resolution protocol messages such as the outdoor name resolution intermediary device 112 on the Internet 106.

The outdoor name resolution intermediary device 112 is located outside the home so that it has a possibility of receiving the name resolution requests from the unspecified many third parties. For this reason, it is preferable to provide a function for authenticating the communication device which communicate with the outdoor name resolution intermediary device 112. In this way, it is possible to limit the utilization of the name resolution system of this embodiment only to the communication devices of the specific users.

FIG. 2 shows an exemplary configuration of the name registration intermediary device 109 in the name resolution system of this embodiment, which comprises a registration request reception unit 201, a registration request conversion unit 202, a registration request transmission unit 203, a registration response reception unit 204 and a registration response transmission unit 206.

The registration request reception unit 201 has a function for receiving an address information registration request from the indoor communication device such as the desk-top PC 105.

The registration request conversion unit 202 has a function for converting a host name portion of the address information registration request received by the registration request reception unit 201.

The registration request transmission unit 203 has a function for transmitting the address information having the converted FQDN obtained by the registration request conversion unit 202 as a registration request to the DNS registration server 108.

The registration response reception unit 204 has a function for receiving a response to the registration request transmitted by the registration request transmission unit 203, from the DNS registration server 108. The received response is given to the registration response transmission unit 205.

The registration response transmission unit 205 transmits the response received by the registration response reception unit 204, either as it is or after appropriately correcting format, etc., to the indoor communication device such as the desk-top PC 105 which sent the registration request to the name registration intermediary device 109. From a viewpoint of the indoor communication device such as the desk-top PC 105, the registration request is transmitted to the name registration intermediary device 109 and a response is received from the name registration intermediary device 109 so that it appears as if the name registration intermediary device 109 has a function of the DNS registration server 108. By providing the name registration intermediary device 109 and operating it as if it is the DNS registration server 108, it becomes possible to conceal the original FQDN by indirectly changing the host name of the address information contained in the registration request according to some rule, without requiring the indoor communication device to implement an additional mechanism.

FIG. 3 shows an exemplary configuration of the name resolution intermediary device 110 in the name resolution system of this embodiment, which comprises a query reception unit 301, a query conversion unit 302, a query transmission unit 303, a query response reception unit 304 and a query response transmission unit 305.

The query reception unit 301 has a function for receiving a name resolution request based on the FQDN (which will be referred to as query) from the indoor communication device such as the desk-top PC 105.

The query conversion unit 302 has a function for converting a host name portion of that FQDN in the query for acquiring the IP address corresponding to the FQDN that is received by the query reception unit 301. The conversion rule for converting the host name at the query conversion unit 302 is the same conversion rule that is used by the name registration intermediary device 109.

The query transmission unit 303 has a function for transmitting the query for requesting the IP address corresponding to the converted FQDN obtained by the query conversion unit 302 to the DNS server 107.

The query response reception unit 304 has a function for receiving a query response to the query transmitted by the query transmission unit 303, from the DNS server 107.

The query response transmission unit 305 transmits the query response received by the query response reception unit 304, either as it is or after appropriately correcting format. etc., to the indoor communication device such as the desk-top PC 105 which sent the query to the name resolution intermediary device 110. From a viewpoint of the indoor communication device such as the desk-top PC 105, the query is transmitted to the name resolution Intermediary device 110 and a response to the query is received from this name resolution intermediary device 110 so that it appears as if the name resolution intermediary device 110 has a function of the DNS server 107. By providing the name resolution intermediary device 110 and operating it as if it is the DNS server 107, it becomes possible to conceal the original FQDN by indirectly changing the host name of the address information contained in the query according to some rule, without requiring the indoor communication device to implement an additional mechanism.

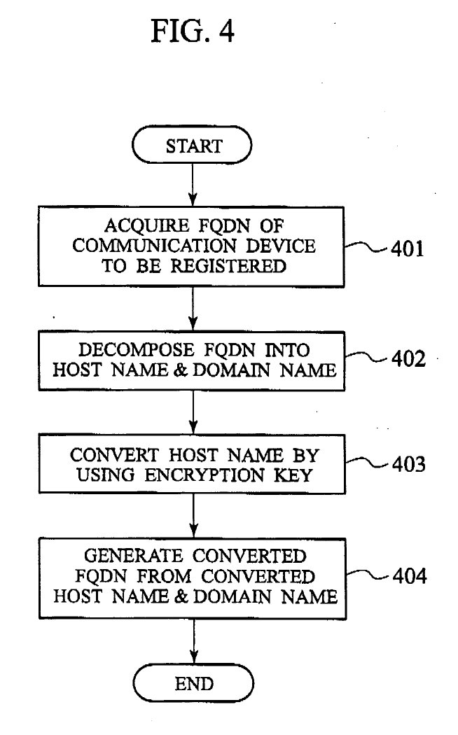

FIG. 4 shows an exemplary procedure for converting the FQDN at the registration request conversion unit 202 in the name registration intermediary device 109 of this embodiment.

The registration request conversion unit 202 acquires the registration request transmitted by the indoor communication device and received by the registration request reception unit 201. The acquired registration request contains the address information which is requested to be registered to the DNS server 107, and the FQDN is extracted from the address information (step 401). Then, the acquired FQDN is decomposed into a host name portion and a domain name portion (step S402). Then, the host name portion is converted by using an encryption key (step S403), and the converted FQDN is generated from the host name after the conversion and the decomposed domain name (step S404).

Here, the encryption key is a secret key information to be disclosed only to those specific users who are permitted to know the existence of the indoor communication devices, which is to be concealed among the specific users. The specific users can be family members living in the same home who share the indoor communication devices, for example. It is preferable to employ a sufficiently strong conversion such that the original host name cannot be revealed easily even if a person who cannot possibly know this encryption key analyzes the host name. The encryption key is not limited to a keyword such as a character string, and may be a calculation formula, function or device which can derive a character string different from the input character string. The encryption key must be set to the name registration intermediary device 109, the name resolution intermediary device 110, and the outdoor name resolution intermediary device 112 provided in the name resolution system of this embodiment.

As the conversion method, it is possible to use the one-way hash function using the encryption key as described above, but any conversion method which is sufficiently strong as described above can be used.

The generated converted FQDN is transmitted to the DNS registration server 108 through the registration request transmission unit 203, and the address information formed by the converted FQDN and the IP address is registered to the DNS server 107.

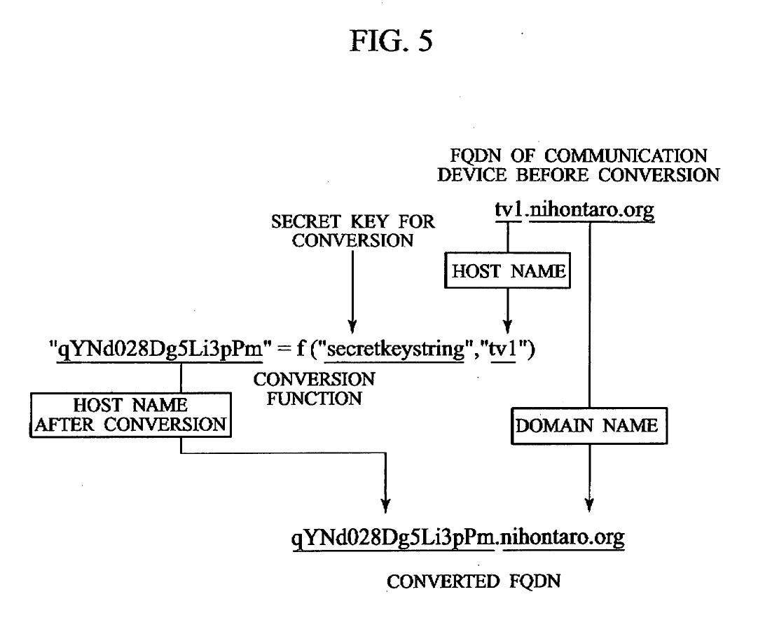

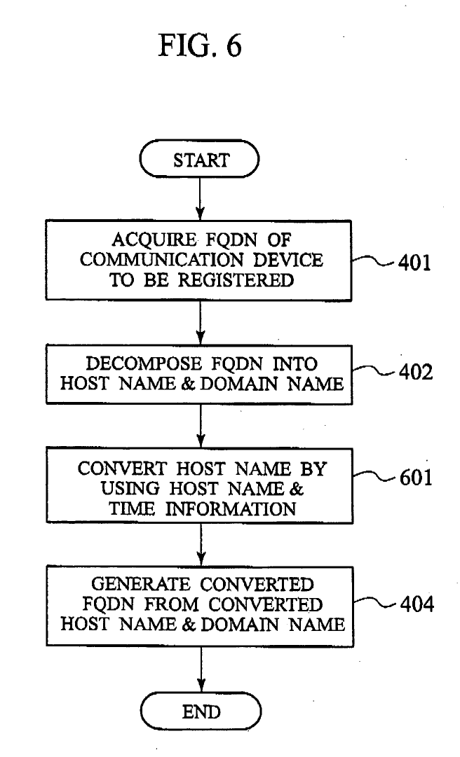

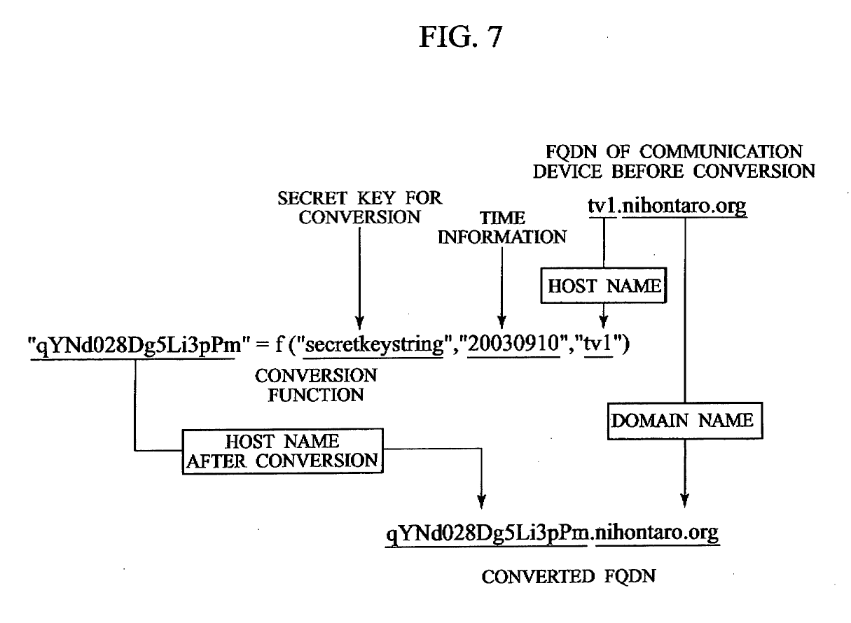

FIG. 5 shows an exemplary host name conversion carried out by the registration request conversion unit 202. Suppose that the FQDN before the conversion of the TV 103 which is the indoor communication device that requests the DNS registration is “tv1.nihontaro.org”. The host name “tv1” is used here so that it is easier for the users to comprehend that it is the first TV connected to the indoor LAN 101. By executing the step 402, the FQDN before the conversion is decomposed into the host name “tv1” and the domain name “nihontaro.org”. Usually, characters up to the first dot from the left are called host name. The host name “tv1” is given as an argument of the one-way hash function along with the encryption key “secretkeystring”, and converted into a totally different character string (step 403). In the example of FIG. 5, the host name after the conversion is given by “qYNd028Dg5Li3pPm”. Finally, the host name after the conversion and the domain name are combined by placing the former on the left side and the latter on the right side to generate the converted FQDN “qYNd028Dg5Li3pPm.nihontaro.org” (step S404).

By using the converted FQDN obtained from the host name by the one-way conversion method, the third person who cannot possibly know the encryption key cannot ascertain the host name before the conversion through the name registration intermediary device 109 which is used in the home, even if it is possible to see the address information registered to the DNS server 107. Also, the host name after the conversion is converted into character string which is unrelated to the original host name, so that it is also impossible to guess what kind of communication device this indoor communication device is, from the address information already registered to the DNS server 107. Consequently, it is possible to realize the name resolution system in which the unspecified many third parties cannot guess a type of the home electronics device or the like that is connected to the Indoor LAN 101,

It is also possible to make the name registration intermediary device 109 to generate a host name randomly or by a prescribed method, in addition to the host name in the address Information of the registration request, and register a generated fictitious converted FQDN along with the domain name to the DNS. Also, Instead of doing that at the name registration intermediary device 109, it is also possible for the indoor communication device such as the desk-top PC 105 to generate a fictitious FQDN from a fictitious host name, and register it to the DNS through the name registration intermediary device 109. In such a configuration, even if address information for all the communication devices having the domain name corresponding to the indoor LAN 101 is extracted from the DNS, the number of the indoor communication devices cannot be ascertained. In this way, it is also possible to conceal the number of the indoor communication devices in addition to the types of the indoor communication devices.

Next, the name resolution method using the DNS server 107 by the name resolution intermediary device 110 of this embodiment will be described The conversion of the FQDN contained in the query which is carried out by the query conversion unit 302 in the name resolution intermediary device 110 is the same as that shown in FIG. 4 and FIG. 5 which is carried out by the registration request conversion unit 202 in the name registration intermediary device 109.

The FQDN of the query received by the name resolution intermediary device 110, such as “tv1.nihontaro.org” for example, is converted into the converted FQDN “qYNd028Dg5Li3pPm.nihontaro.org” similarly as in FIG. 5, and transmitted from the query transmission unit 303 as the query to the DNS server 107.

At this point, if the converted FQDN contained in the address information transmitted to the DNS registration server 108 at a time of the DNS registration by the name registration intermediary device 109 and the converted FQDN of the query transmitted to the DNS server 107 as the query by the name resolution intermediary device 110 are the same, the DNS server 107 will return a response indicating the IP address corresponding to this converted FQDN as a name resolution result. Using a configuration in which the converted FQDN obtained by converting “tv1.nihontaro.org” by the registration request conversion unit 202 in the name registration intermediary device 109 becomes the same as the converted FQDN obtained by converting “tv1.nihontaro.org” by the query conversion unit 302 in the name resolution intermediary device 110, it is just the utilization of the DNS for the FQDN “tv1.nihontaro.org” as long as these intermediary devices are used. Even in this case, the FQDN of the address information registered to the DNS server 107 can be registered in a state of the converted FQDN from which the communication device cannot be ascertained.

On the other hand, if the encryption key of the registration request conversion unit 202 in the name registration intermediary device 109 and the encryption key of the query conversion unit 302 in the name resolution intermediary device 110 are different, the converted FQDN obtained by the two conversion units will be different, so that even if the name registration intermediary device 109 carries out the DNS registration and the name resolution intermediary device 110 tries to carry out the name resolution, the DNS server 107 will return a response indicating “not registered (unresolved)”. Thus the proper name resolution cannot be realized unless the encryption keys of the name registration intermediary device 109 and the name resolution intermediary device 110 coincide. Consequently, it is possible to limit those who can realize the proper name resolution to only the specific users who can know this encryption key.

### Second Embodiment

The name resolution system according to the second embodiment is similar to the name resolution system of the first embodiment so that the differences will be described in detail.

The exemplary configuration of the name resolution system of this embodiment is the same as that of FIG. 1. The exemplary configuration of the name registration intermediary device 109 in the name resolution system of this embodiment is the same as that of FIG. 2. The exemplary configuration of the name resolution intermediary device 110 in the name resolution system of this embodiment is the same as that of FIG. 3. The functions described with references to these drawings are also similar to those of the first embodiment.

FIG. 6 shows an exemplary procedure for converting the FQDN at the registration request conversion unit 202 in the name registration intermediary device 109 of this embodiment.

The registration request conversion unit 202 acquires the registration request transmitted by the indoor communication device and received by the registration request reception unit 201. The acquired registration request contains the address information which is requested to be registered to the DNS server 107, and the FQDN is extracted from the address information (step 401). Then, the acquired FQDN is decomposed into a host name portion and a domain name portion (step S402). Then, the host name portion is converted by using an encryption key and a time information (step S601), and the converted FQDN is generated from the host name after the conversion and the decomposed domain name (step S404). The difference from the first embodiment is that the time information is also used in the conversion of the host name by using the encryption key.

Here, the time information is an information dependent on a time at which the registration request or the query is intermediated, for example. When the registration request is intermediated on Sep. 10, 2003, the address information having the converted FQDN obtained by converting the host name by using the encryption key and a character string such as “20030910” is registered, for example. The time information is used along with the encryption key at a time of generating the converted FQDN, so that the converted FQDN is different when the time information changes. In other words, in the case of using the time information which changes in units of day, the converted FQDN will contain information on the day at which the registration request has been intermediated. The time information may not necessarily be a character string expression using the time directly, and may be a character string expressing a value of a counter which changes at a certain time interval, for example. Any information that changes according to a certain time interval can be used instead.

FIG. 7 shows an exemplary host name conversion carried out by the registration request conversion unit 202. Suppose that the FQDN before the conversion of the TV 103 which is the indoor communication device that requests the DNS registration is “tv1.nihontaro.org”. The host name “tv1” is used here so that it is easier for the users to comprehend that it is the first TV connected to the indoor LAN 101. By executing the step 402, the FQDN before the conversion is decomposed into the host name “tv1” and the domain name “nihontaro.org”. Usually, characters up to the first dot from the left are called host name. The host name “tv1” is given as an argument of the one-way hash function along with the encryption key “secretkeystring” and the time information “20030910”, and converted into a totally different character string (step 601). In the example of FIG. 7, the host name after the conversion is given by “qYNd028Dg5Li3pPm”. Finally, the host name after the conversion and the domain name are combined by placing the former on the left side and the latter on the right side to generate the converted FQDN “qYNd028Dg5Li3pPm.nihontaro.org” (step S404).

By using the converted FQDN obtained from the host name by the one-way conversion method which includes the time information, the proper name conversion cannot be realized unless one knows the time information in addition to the encryption key. This implies that it is possible to limit the function of the name conversion provided by the name resolution system of this embodiment according to a time at which the time information changes, in addition to the effect of the first embodiment.

Next, the name resolution method using the DNS server 107 by the name resolution intermediary device 110 of this embodiment will be described. The conversion of the FQDN contained in the query which is carried out by the query conversion unit 302 in the name resolution intermediary device 110 is the same as that shown in FIG. 6 and FIG. 7 which is carried out by the registration request conversion unit 202 in the name registration intermediary device 109.

The FQDN of the query received by the name resolution intermediary device 110, such as “tv1.nihontaro.org” for example, is converted into the converted FQDN “qYNd028Dg5Li3pPm.nihontaro.org” similarly as in FIG. 7, and transmitted from the query transmission unit 303 as the query to the DNS server 107.

At this point, suppose that the time information at a time of the name resolution is changed from the time information at a time of the registration request. For example, suppose that the time information is expressed by a character string “yyyymmdd” obtained from the year, month and day. In the case where the time information at a time of the DNS registration of “tv1.nihontaro.org” through the name registration intermediary device 109 was “20030910”, the time information at a time of the name resolution through the name resolution intermediary device 110 which is attempted by the indoor communication device such as the desk-top PC 105 next day is “20030911”. Then, as shown in FIG. 8, the converted FQDN “kRnE029Lg54i3poS.nihontaro.org” which is different from that of FIG. 7 is generated because the time information has changed even though the same encryption key is used. The converted FQDN at a time of attempting the name resolution through the name resolution intermediary device 110 next day is different from that contained in the address information registered to the DNS through the name registration intermediary device 109, so that the name resolution by the DNS server 107 fails (unresolved).

In this way, the proper name resolution cannot be realized unless the time information of the name registration intermediary device 109 and the name resolution intermediary device 110 coincide. Consequently, it is possible to limit a period of time during which the proper name resolution of a certain communication device that is registered to the DNS can be realized by changing the time information to set a desired period of time for which the name resolution is to be allowed, with respect to the address information that is registered at a certain time.

### Modification of the Second Embodiment

It is also possible to register a temporary IP address as the IP address of the address information to be registered to the DNS server 107 by the name registration intermediary device 109. For example, it is possible to generate a temporary IP address by using a function such as Privacy Extensions for Stateless Address Autoconfiguration in IPv6 (RFC3041) in the case of IPv6. By setting the temporarily generated IP address to become invalid by a certain time limit on the network, it is possible to limit a period of public disclosure at the IP address level as well.

Usually, the IP address is often assigned fixedly to the communication device such as a server which is presupposed to be accessed from the other communication devices. Also, in IPv6, the IP address automatically generated for each communication device becomes a constant value unless the Address Prefix assigned from the ISP changes. In this case, if the name resolution of an access target communication device is possible even once during the period of public disclosure, there is a possibility that the same server can be accessed by using the already acquired IP address even after the period of public disclosure has elapsed.

By using the name resolution system of this embodiment, it is possible to limit a period of time of the access to a communication device, even if the other communication devices continue to use the IP address of the communication device obtained by the name resolution during the period of public disclosure as a destination.

As described, according to the present invention, it is possible to provide a name resolution system in which the name resolution is possible as usual for specific users, but the name resolution becomes impossible for unspecified many third parties.

It is to be noted that the embodiments described above uses the DNS as an example, but it is also possible to apply the present invention to any system other than the DNS which is aimed at the name resolution.

It is to be noted that the above described embodiments according to the present invention may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art.

In particular, the name registration intermediary device or the name resolution intermediary device of each of the above described embodiments can be conveniently implemented in a form of a software package.

Such a software package can be a computer program product which employs a storage medium including stored computer code which is used to program a computer to perform the disclosed function and process of the present invention. The storage medium may include, but is not limited to, any type of conventional floppy disks, optical disks, CD-ROMs, magneto-optical disks, ROMs, RAMs, EPROMs, EEPROMs, magnetic or optical cards, or any other suitable media for storing electronic instructions.

It is also to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. A name registration intermediary device for intermediating between a name resolution device for obtaining an address of arbitrary communication device from a name of the arbitrary communication device and a communication device which transmits a registration request for registering a set of a name and an address of the communication device as an address information of the communication device to the name resolution device, the name registration intermediary device comprising:
a reception unit configured to receive the registration request from the communication device;
a conversion unit configured to convert an original name of the communication device contained in the registration request into another name by using an encryption key; and
a transmission unit configured to replace the original name contained in the registration request by the another name obtained by the conversion unit, and transmit the registration request containing the another name to the name resolution device.

2. The name registration intermediary device of claim 1, wherein the conversion unit generates the another name in a form of a character string obtained by applying a one-way function using the encryption key to the original name.

3. The name registration intermediary device of claim 1, wherein when the original name contains a domain name indicating an area on a network to which the communication device belongs and a host name for identifying the communication device within the area indicated by the domain name, the conversion unit converts the host name and generates the another name from a converted host name and the domain name.

4. The name registration intermediary device of claim 1, wherein the conversion unit generates the another name by using a time information which has a value changing in time, along with the encryption key.

5. A name resolution intermediary device for intermediating between a name resolution device for obtaining an address of arbitrary communication device from a name of the arbitrary communication device and a communication device which transmits a name resolution request for requesting a name resolution of a desired communication device to the name resolution device, the name resolution intermediary device comprising:
a reception unit configured to receive the name resolution request from the communication device;
a conversion unit configured to convert an original name of the desired communication device contained in the name resolution request into another name by using an encryption key; and
a transmission unit configured to replace the original name contained in the name resolution request by the another name obtained by the conversion unit, and transmit the name resolution request containing the another name to the name resolution device which registers the desired communication device by using the another name.

6. The name resolution intermediary device of claim 5, wherein the conversion unit generates the another name in a form of a character string obtained by applying a one-way function using the encryption key to the original name.

7. The name resolution intermediary device of claim 5, wherein when the original name contains a domain name indicating an area on a network to which the communication device belongs and a host name for identifying the communication device within the area indicated by the domain name, the conversion unit converts the host name and generates the another name from a converted host name and the domain name.

8. The name resolution intermediary device of claim 5, wherein the conversion unit generates the another name by using a time information which has a value changing in time, along with the encryption key.

9. A name resolution system for obtaining an address of arbitrary communication device from a name of the arbitrary communication device, the name resolution system comprising:
a conversion unit configured to convert an original name of a communication device into another name by using an encryption key;
a memory unit configured to store the another name obtained by the conversion unit and an address of the communication device in correspondence;
a registration request reception unit configured to receive from a certain communication device a registration request for registering a set of a first original name and a first address of the certain communication device as an address information of the certain communication device;
a first control unit configured to control the conversion unit to convert a first original name contained in the registration request into a first another name, and control the memory unit to store the first another name obtained by the conversion unit and the first address contained in the registration request in correspondence, when the registration request is received by the registration request reception unit;
a search unit configured to search a specific another name stored in the memory unit, and retrieving a specific address stored in the memory unit in correspondence to the specific another name;
a name resolution request reception unit configured to receive from one communication device a name resolution request for requesting a name resolution of a desired communication device;
a second control unit configured to control the conversion unit to convert a second original name of the desired communication device contained in the name resolution request into a second another name, and control the search unit to retrieve a second address stored in the memory unit in correspondence to the second another name obtained by the conversion unit, when the name resolution request is received by the name resolution request reception unit; and
a transmission unit configured to transmit the second address retrieved by the search unit as a response to the name resolution request to the one communication device.

10. The name resolution system of claim 9, wherein the conversion unit generates the another name in a form of a character string obtained by applying a one-way function using the encryption key to the original name.

11. The name resolution system of claim 9, wherein when the original name contains a domain name indicating an area on a network to which the communication device belongs and a host name for identifying the communication device within the area indicated by the domain name, the conversion unit converts the host name and generates the another name from a converted host name and the domain name.

12. The name resolution system of claim 9, wherein the conversion unit generates the another name by using a time information which has a value changing in time, along with the encryption key.

13. A name resolution method for obtaining an address of arbitrary communication device from a name of the arbitrary communication device, the name resolution method comprising:
(a) receiving from a certain communication device a registration request for registering a set of a first original name and a first address of the certain communication device as an address information of the certain communication device;
(b) converting the first original name of the certain communication device into a first another name by using an encryption key;
(c) storing the first another name and an address of the certain communication device in correspondence in a memory;
(d) receiving from one communication device a name resolution request for requesting a name resolution of a desired communication device;
(e) converting a second original name of the desired communication device into a second another name by using the encryption key;
(f) searching the second another name stored in a memory, and retrieving a second address stored in the memory in correspondence to the second another name; and
(g) transmitting the second address as a response to the name resolution request to the one communication device.

14. The name resolution method of claim 13, wherein each one of the steps (b) and (e) generates a respective another name in a form of a character string obtained by applying a one-way function using the encryption key to a respective original name.

15. The name resolution method of claim 13, wherein when an original name contains a domain name indicating an area on a network to which a respective communication device belongs and a host name for identifying the respective communication device within the area indicated by the domain name, each one of the steps (b) and (e) converts a respective host name and generates a respective another name from a respective converted host name and a respective domain name.

16. The name resolution method of claim 13, wherein each one of steps (b) and (e) generates a respective another name by using a time information which has a value changing in time, along with the encryption key.

17. A computer program product for causing a computer to function as a name registration intermediary device for intermediating between a name resolution device for obtaining an address of arbitrary communication device from a name of the arbitrary communication device and a communication device which transmits a registration request for registering a set of a name and an address of the communication device as an address information of the communication device to the name resolution device, the computer program product comprising:
a first computer program code for causing the computer to receive the registration request from the communication device;
a second computer program code for causing the computer to convert an original name of the communication device contained in the registration request into another name by using an encryption key; and
a third computer program code for causing the computer to replace the original name contained in the registration request by the another name obtained by the conversion unit, and transmit the registration request containing the another name to the name resolution device.

18. The computer program product of claim 17, wherein the second computer program code generates the another name in a form of a character string obtained by applying a one-way function using the encryption key to the original name.

19. A computer program product for causing a computer to function as a name registration intermediary device for intermediating between a name resolution device for obtaining an address of arbitrary communication device from a name of the arbitrary communication device and a communication device which transmits a name resolution request for requesting a name resolution of a desired communication device to the name resolution device, the computer program product comprising:
a first computer program code for causing the computer to receive the name resolution request from the communication device;
a second computer program code for causing the computer to convert an original name of the desired communication device contained in the name resolution request into another name by using an encryption key; and
a third computer program code for causing the computer to replace the original name contained in the name resolution request by the another name obtained by the conversion unit, and transmit the name resolution request containing the another name to the name resolution device which registers the desired communication device by using the another name.

20. The computer program product of claim 19, wherein the second computer program code generates the another name in a form of a character string obtained by applying a one-way function using the encryption key to the original name.
